(19) United States
(12) Patent Application Publication
(10) Pub. No.: US 2009/0119572 A1
(43) Pub. Date: May 7, 2009

(54) SYSTEMS AND METHODS FOR FINDING INFORMATION RESOURCES

(76) Inventor: Marja-Riitta Koivunen, Lexington, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/263,664

(22) Filed: Nov. 3, 2008

Related U.S. Application Data
(60) Provisional application No. 60/984,888, filed on Nov. 2, 2007.
(60) Provisional application No. 61/013,787, filed on Dec. 14, 2007.

(51) Int. Cl. G06F 17/20; G06F 17/30

(52) U.S. Cl. 715/206; 707/103 R

(57) ABSTRACT

A semantic service system may includes a tagging facility for collecting references to resources thereby providing tagged resources; a semantic database for storing the collected references; a semantic associating facility for determining semantic relationships among the references and the resources thereby providing semantic objects; and a user interface for presenting context-based views of one or more of the semantic objects, the references, and the tagged resources. A handheld tagging device includes a computing facility with a camera for acquiring images of resources and a motion sensor for detecting a tagging gesture.

### CROSS-REFERENCE TO RELATED APPLICATIONS

This application claims the benefit of the following provisional applications, each of which is hereby incorporated by reference in its entirety:

U.S. App. No. 60/984,888 filed Nov. 2, 2007; and U.S. App. No. 61/013,787 filed Dec. 14, 2007.

### BACKGROUND

1. Field

The methods and systems disclosed herein relate to organizing access and presentation of electronic information. In particular the methods and systems herein relate to information management systems and methods that capture and utilize semantics.

2. Description of the Related Art

Users of information need easy-to-use solutions to effectively share, organize, and search a quickly expanding information sources. Users want to use their own vocabularies and view the world of information integrated with their current context. Users also need ways to efficiently and dynamically share information, such as with personal and business collaborative groups. In addition, companies and other organizations need cost effective, dynamic, manageable and flexible ways to find and share information to enable connection and collaboration among people who may not be closely related, remotely located, belong to different organizations, and even use different vocabularies. Finding and sharing information among an increasing diversity of personal computing systems and mobile devices is also critical to meet these objectives.

More and more of the information will be created, shared, organized and viewed through mobile devices. By December 2007 there were over 3.3 billion mobile phone subscribers thus reaching an equivalent of over half the planet's population. It is estimated that 90% of world's population will have access to mobile phone coverage by 2010. Mobile phones are rapidly evolving into network connected computing devices that have a lot of interactive functionality. Some smart phones and other mobile devices have enough computing capacity to run multiple applications including the following: access contacts in phonebook, make phone calls, send and receive email and instant messages, browse internet content, make bookmarks, take and view photos and videos, view maps, use navigation and save landmarks and routes, listen to music, edit and save playlists, play games, as well as create multimedia content and share all of the above with other users. Additionally, many mobile user interfaces emphasize the current context to enable a large number of capabilities with just a few user interaction features and buttons. Therefore mobile users may expect and therefore may benefit from information being accessible through similar current context means.

Devices designed for mobile usage typically have a small form factor, small keypads, and small display screens thus limiting the access to this functionality. User interfaces typically have icons and menus, with limited capability to customize and organize the rich information and media that these devices are capable of producing. Recently expansion of cellular 3G networks has provided improved access to the Internet; it is now possible to collaboratively share, organize, filter, and find information and resources among mobile and computing devices such as PCs. In essence, mobile phones are changing into life recording and sharing devices.

As over 3 billion people are using mobile phones on daily basis these trends will result in explosion of rich information, including a substantial amount of user generated or adapted information. Therefore mobile users will need easy-to-use solutions to effectively share, organize, and search the quickly expanding information space.

Likewise, people use computers to manage information, which includes retrieving, sharing, and organizing information. For example, people use search engines to conduct keyword searches of web pages and other electronic files.

Keyword searches and the like are convenient in that they use information within the electronic files as a search key—no supplemental information is required to run a keyword search against a document. Moreover, keyword searches are convenient when there is little ambiguity about a word's meaning and when the person running the search knows the word. For example, when a person wants to find an item for sale on an ecommerce site, and the person knows the exact name of the item, a keyword search against all items at the ecommerce site will turn up the desired item.

More generally, however, people manage information for the purpose of gaining some knowledge that they do not prepossess. This leads to a variety of scenarios in which managing information with respect to its semantics may be desirable.

In one such scenario, a person may not have a complete vocabulary to describe what the information he seeks. For example, someone interested finding articles related to the profit that a government makes by minting money may not know the word ‘seigniorage’.

In another such scenario, different people may have different vocabularies to describe the same thing. For example, today a high school student in the United States might want to find historical texts relating to the U.S. Civil War. Depending upon the vocabulary of the authors who wrote the texts, the U.S. Civil War might be referred to as the War of the Rebellion, the War for Southern Independence, the War of Northern Aggression, the War in Defense of Virginia, Mr. Lincoln's War, the War of Secession, the War of the Insurrection, the Slaveholders War, the Great Rebellion, the War to Save the Union, and so on—all terms that refer to the same thing, albeit from different perspectives.

In yet another such scenario, two people may have the same vocabulary, but ascribe different meanings to the information being sought. As a simple example, consider an information set containing just three images: a dog, a bone, and a cat. A person has access to the dog image, and now wants to find images that are associated with the dog. A recent study has shown that about half of people will consider the bone as the more appropriate result; while the other half will think the cat is more appropriate. It follows that, absent user-provided semantics, an information system or method that is employed to find the image that is associated with the dog can have no more than a 50/50 chance of providing the “right” image to the person in this scenario.

Many other such scenarios will be appreciated. In any case, the point is that information management absent semantics only gets one so far.

There remains a need for information management systems and methods that capture and utilize semantics.

### SUMMARY

Embodiments of the present invention include information systems and methods that capture and utilize semantics. In an embodiment a semantic service system provides a framework for users to share, organize, filter and find information with innovative, flexible ways to use their own vocabularies and views of the world. A semantic service system may consist of services, browser plug-ins and other components that support users in creating, saving, sharing and viewing semantic objects, providing different presentations that combine information from other services, providing user interfaces to view semantic objects and combined information in new, flexible, and different ways.

A semantic service system may facilitate users storing and searching semantic based bookmarks and topics, sharing selected bookmarks and topics with other users, view combinations of bookmarks and topics in several user friendly ways, form hierarchies and collections of semantically related topics, use bookmark and topic collections to enrich search engine results, store different types of information in bookmarks and topics such as geographic locations, and the like. Topic collections and/or hierarchies can be indexes, playlists of music or videos, lists of terms, lists of genres, labels for temporal workflow, labels for locations, spatial events, user profile components, and the like. Bookmarks can be pointers to content (e.g. a URI, or a detail that is identified by a URI) or to any variety of identifiable items including documents, media, advertisements, locations, devices, goods, content representing humans, animals, plants, and the like. Both topics and bookmarks can point to locally stored resources on a device or remotely stored resources such as resources of a service. Topics and bookmarks can themselves be stored in services, locally, in documents located in different devices, distributed on the Internet, and the like. Topics and bookmarks can be connected through sameness properties, such as semantic properties

A semantic service system may facilitate user created combinations of topics, bookmarks, annotations and the like. A semantic service system may enable a user to bookmark annotations to effectively name concepts and parts of multimedia objects or categorize parts of media objects such as a tumor in a radiological image, a familiar face in a photograph, an advertisement in a video or streaming content, and the like. By providing features and capabilities that extend the use and value of bookmarks, topics, and the like through semantic interpretation, places or locations (e.g. landmarks) may be bookmarked, devices with detectable IDs such as RFID, barcode, 2D code, and the like may be bookmarked (e.g. IDmark), email, blogs, RSS feeds and the like may be bookmarked and associated with topics, topic groups or collections may be easily and automatically generated from documents, selected text, automatically delivered content, and the like. Bookmarks, topics, and or collections of bookmarks or topics may be used to order and/or filter other resources (search results, e-commerce related products or services, and the like). Topic collections and hierarchies may be automatically and dynamically populated with sample bookmarks and with similar content from other services and sources to create on-demand topic collections or to discover associations among content sources.

A semantic service system may provide advantages such as user centered features that allow users to start with their own vocabularies, organize them in hierarchies and collections, and learn and add related vocabularies in their own pace; user centered control that allows user to store vocabularies and bookmarks in several services, such as company services, public services, and combinations of services; multiple topics per bookmark that facilitate connecting topics and viewing topics and bookmarks in different ways; semantic properties of other systems can be combined with semantics known to the semantic service system; and differentiating topics with substantially the same textual representation but different meanings.

Elements that may be included in a semantic service system, such as Annotea objects and semantic objects may act as metaphors that successfully hide the underlying semantic web technologies from the users so that users can use semantic web concepts fluently without even knowing about them. It may be sufficient for users to know how to subscribe to data stores containing various Annotea objects. A user interface associated with a semantic service system may facilitate such actions. To further increase the usability of semantic web technologies, data stores can include one or more of local files, server files, web documents, and the like. In an embodiment, web documents may offer users an easy alternative to get started with semantic web concepts without requiring an investment in a server. Web documents can also be used to archive snapshots of selected Annotea objects separate from a local or server based data store.

One of many benefits of information systems and methods that capture and utilize semantics is that user generated data, such as metadata, topics, facets, bookmarks, and the like can easily be combined and reused in many other applications including without limitation: user profiles for services, data mining, organizing blogs, email, chat rooms, RSS feeds, search engine applications, and the like. An additional benefit is that semantic based bookmarks and topics help ordinary users organize and classify any digital information with their own personal concepts (e.g. folksonomies). These concepts can be simple or hierarchical and hierarchies can be combined for use as one or more facets. Also, users can collaborate, explore, and innovate in their own current context by sharing concepts and bookmarks with other users. Users can also link their concepts to other users' concepts through the associative nature of semantic objects and Annotea objects.

In an aspect of the invention a semantic service system may include: a tagging facility for collecting references to resources, providing tagged resources; a semantic database for storing the collected references; a semantic associating facility for determining semantic relationships among the references and the resources, providing semantic objects; and a user interface for presenting context-based views of one or more of the semantic objects, the references, and the tagged resources. The tagging facility may include a handheld tagging device. The handheld tagging device may include a computing facility with a camera for acquiring images of resources. The handheld tagging device may also include a motion sensor for detecting a user tagging gesture. Also, the handheld tagging device may include a camera enabled mobile phone adapted to provide a tagged image of a object in a field of view of the camera. The tagging facility may include a computer user input device for receiving a user tag action.

In the aspect, the references to resources may include bookmarks. The semantic objects may include one or more of annotations, bookmarks, topics, facets, folkcets, folksonomies, and annomind objects. Also, the semantic objects may include a unique ID that facilitates distinguishing between two semantic objects with identical content. In this aspect, the distinction may be a semantic different, a user defined difference, or may be associated with a context-based view.

In the aspect, the user interface may include a web browser or a plug-in for a web browser.

Also, the semantic associating facility may transform a portion of the collected references based on references in the semantic database.

In another aspect of the invention, a method of integrating content with presentation may include: generating content by referencing a set of semantic objects; customizing a presentation widget; integrating the generated content with the customized presentation widget, providing an annolet; identifying the annolet; and associating semantic information with the annolet.

In the aspect, referencing may include one or more of tagging and bookmarking. Generating content may include coping content from a resource identified by the set of semantic objects. Customizing a presentation widget may include a presentation order of the generated content.

In this aspect, integrating may include referencing one or more annomind objects to select a subset of the generated content. The set of semantic objects may be selected from a list consisting of annotations, bookmarks, topics, facets, facet spaces, folkcets, and folkcet spaces. The presentation widget may be adapted based on one or more related annomind objects. Also, the one or more annomind objects may be selected from a set consisting of annotations, bookmarks, topics, facets, facet spaces, folkcets, and folkcet spaces.

In another aspect of the invention, a method of generating a user authored, dynamically updated reference may include: receiving a user tagging action; determining a resource associated with the tagging action; determining a plurality of semantic aspects of the resource; and presenting a portion of the plurality of semantic aspects based on the user context. The user tagging action may be implicit. The user authored, dynamically updated reference may be a semantic object and the semantic object may be automatically generated. Alternatively the semantic object may be a landmark object or an annolet. Also, the user context may include a topic. The method may further include associating the user generated dynamically updated reference with a topic.

In an aspect of the invention, methods and systems of dynamic facet creation, may include: taking social topic hierarchies; associating a user determined facet with a portion of the social topic hierarchies; adding topics to the social topic hierarchies; and associating the user defined facet with the added topics based on a semantic analysis of the added topics. In the aspect, the facets are dynamically created and/or created in real-time.

Further in the aspect, the methods and systems may include determining a value of the user defined facet and, based on the value performing one of sharing the user defined facet and marking the user defined facet. In the aspect, marking includes marking the user defined facet as a deprecated facet. Also in the aspect, the value is determined by a common policy associated with the social topic hierarchies or by usage of the facet.

In another aspect of the invention, methods and systems for presenting topics a subtopics may include: creating a first facet; taking topics that are associated with a second facet; associating the first facet with the topics based on a semantic analysis of the topics; and presenting the topics so that topics that are associated with the first facet are presented as subtopics of the second facet. In this aspect, the subtopics are visually distinct.

In another aspect of the invention, methods and systems for presenting topics a subtopics may include: taking a first facet; taking topics that are associated with a second facet; associating the first facet with the topics based on a semantic analysis of the topics; and presenting the topics so that topics that are associated with the first facet are presented as subtopics of the second facet. In this aspect, the subtopics are visually distinct.

In yet another aspect of the invention, methods and systems may include a method of page ranking that may include: receiving a link structure for page ranking; receiving a folkcet; selecting a subset of links from the link structure based on a semantic association of the link structure and the folkcet; and presenting the selected subset of links as ranked pages.

In another aspect of the invention, a method of page ranking may include: receiving a search query; determining a folkcet that is associated with the query; and calculating a page rank for candidate search query results based on a similarity of the candidate result to the folkcet. In this aspect, the folkcet is one of user specified and automatically generated based on a query.

In another aspect of the invention, a method of folkcet focused search ma include: receiving a search query; receiving a plurality of search query results; determining a folkcet that is associated with the query; and focusing the search query results based on the folkcet. In this aspect, the folkcet is one or more of user generated, user-generated facets, automatically generated based at least in part on the search query. The method further including presenting the folkcet-focused search results to a user.

In an aspect of the invention, a method of providing a user profile may include: providing a user bookmark collection; receiving a user request to access a network resource; selecting a portion of the bookmark collection based on the request; and providing a user profile based on the selected portion to the resource. In the method the user bookmark collection is a folkcet. The folkcet may include folksonomies, and user facets. In this aspect, the network resource may be a web site. In this aspect, providing a user profile includes submitting information from a client based internet cookie.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 shows a system 100 that enables a user to share, organize, filter, and find information.

FIG. 2 shows a method that produces a document including semantic relationships.

FIG. 3 shows an augmented version of the method of FIG. 2.

FIG. 4 shows a method that associates a user-defined facet with a topic based upon semantic analysis.

FIG. 5 shows an augmented version of the method of FIG. 4.

FIG. 6 shows a method that enables sharing of topic subclasses.

FIG. 7 shows a method that presents ranked pages by using a folkcet.

FIG. 8 shows a method that calculates a page rank using a folkcet.

FIG. 9 shows a few bookmark view screens.

FIG. 10 shows semantic authoring of a bookmark hierarchy.

FIG. 11 shows a user interface for traversing from a pagemark to topics and related bookmarks.

FIG. 12 shows topics for a workflow status embodiment.

FIG. 13 shows topics for a content label embodiment.

FIG. 14 shows a user interface of a semantic service system.

### DETAILED DESCRIPTION

Embodiments of the present invention are directed at capturing and utilizing semantics in information management. Without limitation, semantic information may be referred to herein and elsewhere at least as topics, bookmarks, annotations, facets, and annolets.” Topics may be drawn from folksonomies, existing vocabularies, ontologies, and so on. Topics may be related to one another through common topics, standard concepts, and so on. Unless otherwise stated or clear from the context, topics should be understood to include any and all semantic information. Similarly, unless otherwise stated or clear from the context, any and all topics may be subtopics of any and all other topics.

Topics may be organized into sets. Without limitation, these sets may be referred to herein and elsewhere as “folkcets.” Although the word folkcet might seem to allude to the use of a folksonomy, a folkcet may or may not include topics drawn from a folksonomy. In some embodiments, a topic set may include a Boolean definition (e.g. is-a-subtopic-of X), which may enable operations such as “show me all topics that are a subtopic of X.” It will be understood that a variety of Boolean definitions are possible and all such definitions are within the scope of the present disclosure.

Topics may be applied to or associated with information resources or real-world objects that can be given a information identifier such as a URI. In embodiments, the topics may include semantic objects with identifiers. In some embodiments, the identifiers may be universally unique identifiers. Without limitation, information resources may include electronic documents such as text files, multimedia files, data sets, and so on, any and all of which may be stored in a proprietary or open data format on a local or remote data storage facility. The topics and their association with the information resources may be stored in a database or in the information resources themselves. In embodiments, the information resources may be represented as Uniform Resource Identifiers. Throughout this disclosure and elsewhere the word “resource” may be used as shorthand referring to an information resource.

Unless stated otherwise or clear from the context, electronic documents may include any and all forms of digital data stored in any and all formats on any and all media. Throughout this disclosure and elsewhere, the word “document” may be used as shorthand referring to an electronic document. Unless stated otherwise or clear from the context, references to a document should be understood as an example of a information resources. Thus, subject to the foregoing condition, examples or embodiments that are described with respect to a document should be understood to broadly encompass information resources.

In embodiments, the associations between topics and electronic documents may be protected by access controls. In such embodiments, a user may need to provide credentials, subscribe to a service, use an authorized machine, or the like in order to read, add, change, or utilize the topics and their associations with the electronic documents.

Generally, embodiments of the present invention may provide or be operatively coupled to a user interface. It will be understood that a user may access the user interface via a cell phone, web browser, application window, voice prompt, portable digital assistant, portable digital media player, and so on. Moreover, it should be appreciated that the user interface may be provided by a local application in a device, and that the device may or may not be connected to a network. For example and without limitation, the device may be an Apple iPhone and the user interface may be provided by an application that accesses remote data via a network connection of the iPhone. For another example and also without limitation, the device may be a doctor's handheld assistant that contains a database of medical information, the information managed by an application on the device providing a user interface to a user. Still other examples will be appreciated and all such examples are within the scope of the present disclosure.

Throughout this disclosure and elsewhere, when it is said that a user does something it should be understood that such action may be taken by the user via a user interface having appropriate adaptations. So, for example, in the following paragraph when the user is said to “apply topics” it should be understood that the user's application of topic might be done via a user interface having adaptations that allow the user to apply the topic. It will be understood that a variety of user interfaces having such adaptations are possible, and all such user interfaces are within the scope of the present disclosure.

In embodiments, a user may apply topics to documents; create bookmarks (containing topics) for documents; and so on. In embodiments, users may define topics and bookmarks and share them with each other.

In embodiments, a user may search, filter, browse, and order topics, bookmarks, users, and data. These actions may be directed at bookmarks that are related through topic relations; topics that are related through bookmarked resources; topics that are related through topic hierarchies and facet collections; users that are related through topics or bookmarks; topics or bookmarks that are related through users or groups of users; bookmarks, topics, or data that are related through explicit user-generated relations; topics or bookmarks; and so on.

In embodiments, one or more users may initiate the creation of topical models, which may include an ontology of topics, a hierarchy of topics, and so on. In some embodiments, the development and evolution of such user-initiated models may be under the control of users (as opposed to being predetermined or modified by a non-user administrator or the like). Naturally, imperfections and redundancies may work their way into such models the one or more users update them. However, since these models are the users' own, the user may employ them immediately (since it is the user that has breathed meaning into them, there is nothing for the user to learn before employing them).

It should be appreciated that the models may be employed within a faced classification system, which allow the assignment of a plurality of classifications to an object and enable the classifications to be ordered in a plurality of ways. The facets themselves may relate to various attributes (i.e., aspects, properties, characteristics, or the like) of a class or subject. In some embodiments, the attributes may be drawn from an orthogonal set of categories. For example, a song facet in a music catalog may include an artist, a title, a length, a genre, a date of publication, and so on. The facets may be mutually exclusive and develop over time, in parallel, based upon user input.

Faceted classification may be used in faceted search systems that enable a user to navigate information along multiple paths corresponding to different orderings of the facets. This contrasts with traditional taxonomies in which the hierarchy of categories is fixed and unchanging.

In embodiments, the model may be separate from a presentation of the model (i.e. the view). In other words, a model may be represented in one way but presented in any and all of a variety of ways. For example and without limitation, the view may include a flat representation, a hierarchical representation, a mind map, and so on.

In embodiments, models that are under non-user administrative control may exist. A user may select such models for faceted searches or other views such as creating a mind map image of the topics in the model.

As users develop their models, they may realize that certain topics in topic hierarchies should have been defined as a facet. For example, such topics may exist under the same or different names in multiple places within the topic hierarchies. In embodiments, the user may use a topic set to define a broader concept from narrower topics. The user may then view the narrower topics linked to the broader topic set, which itself shows the combined narrower topics. The user may also view this topic set as a virtual topic hierarchy facet containing e.g. all bookmarks associated with at least one of the narrower topics in the set.

In embodiments, a user may view bookmarks that belong to many topics or facets. Topics or facets under a certain topic X may be presented either as a list or as a group (as though the other topics were not facets but subtopics of the topic X). The user may access a link associated with each topic, the link providing access to some or all of the content of each topic. In some embodiments, a visual indication may alert the user as to which topics are singleton topics and which topics are topic groups or facets masquerading as singleton topics.

In embodiments, a topic set may be used to select a Boolean combination of several topics. A user may view the combination, which may be accessible via a URI or the like. The user may indicate that the topic set should appear in a topic hierarchy, perhaps along with additional topics, bookmarks, and the like. When bookmarks belong to such a topic set, the user may indicate that the bookmarks should be shown only under the set.

The user may view bookmarks under a topic tree in a variety of ways. In embodiments, the user may browse one topic level at a time; may browse the topics as an opened topic/subtopic hierarchy in which all bookmarks appear directly under the topics to which they belong; and so on. It will be understood that a variety of views of a hierarchy or tree are possible. All such views are within the scope of the present disclosure.

In embodiments, URIs or other such links or identifiers may be associated with topics, topic sets, or combination topic sets (e.g. sets containing topics, bookmarks, and so on). Such URIs may make the topics, topic sets, or combination topic sets accessible from any and all documents or software applications. A variety of such uses of the URIs will be appreciated, and all such uses are within the scope of the present disclosure.

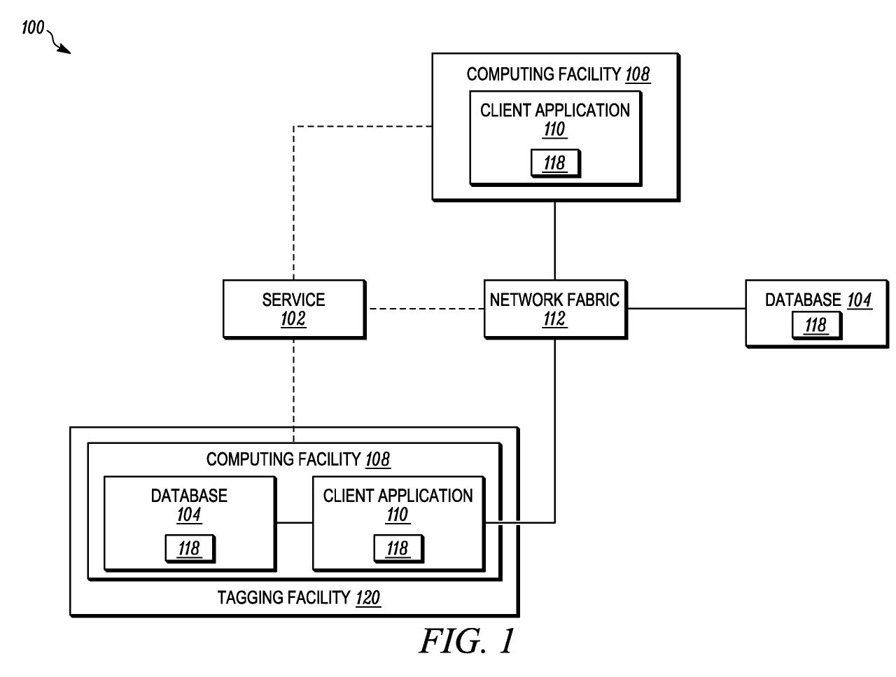

FIG. 1 shows a system 100 that enables a user to share, organize, filter, and find information. The system 100 includes a service 102, a database 104, a computing facility 108, a client application 110, network fabric 112, resources 114, semantic objects 118, and a tagging facility 120.

In embodiments, the resources 114 and semantic objects 118 may reside in one or more databases 104. Some of the databases 104 may be operatively coupled to some computing facilities 108 via the network fabric 112. Some computing facilities 108 may include some of the databases 104. A plurality of client applications 110 may be present, each one of which may reside within a computing facility 108.

The service 102 may be a collection of services that can be connected or linked together via networking fabric 112. The service 102 may include at least one of social bookmarking, tagging, annotating, social networking, media sharing, and so on. The service 102 may store the client application 110 and have ability to update it via network fabric 112. The service 102 may include or provide an application-programming interface (API). The service 102 may be a product of interactions between any and all of the other elements in FIG. 1. In embodiments, each of the client applications 110 may include software instructions that, when carried out by a computing facility 108, produce a user interface to the service 102.

In some embodiments, the service 102 may receive information from the computing facility 108 or the client application and then store the information into the database 104. In some embodiments, the service 102 may require users of client application 110 to authenticate using username and password, or some other means of authentication. In some embodiments, the service 102 may direct users to perform actions by providing web pages in a format that the client application 110 may use to display for the user.

The service 102 may direct the computing facility 108 to perform an action using API of the client application 110. The service 102 may provide access to APIs of the service 102 from the client application 110 in order to enable the client application 110 to retrieve information from the database 104. The service 102 may provide resources 114 that are created using information from the database 104.

The database 104 may include any and all kind of database such as and without limitation a relational database, an object-oriented database, an object-relational database, an XML database, a Semantic Web database possibly with a SPARQL endpoint, and so on. In some embodiments, the database 104 may include a collection of statements that are formatted according to a Resource Description Framework (RDF). It will be appreciated that such statements may represent a labeled, directed multi-graph. In embodiments the database 104 may include a persistent RDF triplet data model, which may represent statements relating to a Web resource in the form of a subject-predicate-object expression. In some embodiments, the database 104 may include a data access layer that provides tools to extract, transform, and load data. In some embodiments, the database 104 may include a metadata dictionary of data in the database 104.

A sample bookmark and topic implemented in RDF is shown here:

```
<RDF:RDF xmlns:foaf=“http://xmlns.com/foaf/0.1/”
    xmlns:dc=“http://purl.org/dc/elements/1.1/”
    xmlns:bm=“http://www.w3.org/2002/01/bookmark#”
    xmlns:a=“http://www.w3.org/2000/10/annotation-ns#”
    xmlns:RDFS=“http://www.w3.org/2000/01/rdf-schema#”
    xmlns:RDF=“http://www.w3.org/1999/02/22-rdf-syntax-ns#”>
  <bm:Bookmark RDF:about =
  “http://mydomain.org/AnnoteaURI/exBookmark”
      dc:title = “The Whole Brain Atlas”
      dc:date = “Mon, 15 May 2006 14:28:32 GMT”
      a:created = “Mon, 15 May 2006 14:28:32 GMT”
      dc:description = “The Whole Brain Atlas is intended as
        an introduction to basic neuroanatomy, with emphasis
        on the pathoanatomy of several leading central nervous
        system diseases.”
      dc:creator = “Marja”>
    <bm:recalls RDF:resource =
      “http://www.med.harvard.edu/AANLIB/home.html”/>
    <foaf:maker RDF:resource =
      “http://www.annotea.org/marja#marja”/>
    <bm:hasTopic RDF:resource =
    “http://mydomain.org/AnnoteaURI/exTopic”/>
    <RDFS:seeAlso RDF:resource =
      “http://big.sfn.org/NDG/site/eavData.asp?o=28952”/>
  </bm:Bookmark>
  <bm:Topic RDF:about = “http://mydomain.org/AnnoteaURI/exTopic”
      dc:title = “Brain collections”
      dc:date = “Mon, 15 May 2006 14:23:32 GMT”
      a:created = “Mon, 15 May 2006 14:23:32 GMT”
      dc:creator = “Marja”>
    <foaf:maker RDF:resource =
      “http://www.annotea.org/marja#marja”/>
    <bm:subTopicOf RDF:resource =
“http://mydomain.org/AnnoteaURI/exParentTopic”/>
  </bm:Topic>
</RDF:RDF>
```

Bookmarks and topics may have many common properties with other Annotea and semantic objects. Referring to the RDF example above, the objects can have a title (dc:title), a longer description (dc:description), information about their author (dc:creator and foaf:maker), the creation date (a:created), the modification date (dc:date), and links to other related information (RDFS:seeAlso). In addition, a bookmark may have information about the page it recalls (bm:recalls), and zero or more topics (bm:hasTopic). A topic may have information about its parent topic (bm:subTopicOf). In addition, new properties can be easily added.

The computing facility 108 may include a personal computer, a workstation, a server, a mainframe, a virtual machine, a modular computer in a blade server, a set-top box, a game console, a network appliance, and so on. In embodiments, the virtual machine may exist in a cloud-based computing center, a modular computer in a blade server, and so on. The computing facility 108 may include one or more networking interfaces that facility communication between the computing facility 108 and the networking fabric 112. The computing facility may include one or more input and output devices such as and without limitation a display, a keyboard, a keypad, a touch screen, a microphone, a loudspeaker, a camera, a GPS receiver, an accelerometer, and so on. In some embodiments the personal computer may include the client application 110. In some embodiments, the computing facility 108 may be portable. In embodiments, one or more computing facilities 108 may provide the service 102. It will be understood that a variety of computing facilities 108 are possible.

For example and without limitation, in some embodiments the computing facility 108 may include a mobile device. The mobile device may comprise a mobile phone, a smart phone, a media player, a personal digital assistant (PDA), a navigation device, a digital camera, a digital video device, an Internet tablet, a netbook, a laptop, and so on.

The client application 110 may include any and all kind of client application such as and without limitation a web browser, an executable, a script, and so on. In some embodiments the client application 110 may be received at a computing facility 108 via the networking fabric 112. In embodiments the client application 110 may include logic to provide information to a server 102. This information may be provided periodically, from time to time, or based upon events that are generated by a user or another client application 110. In any case, the client application 110 may provide information in real time or in batches. The client application 110 access resources using a URI provided by the service 102. The client application 110 may store resources as objects on the computing facility 108. In some embodiments such resources may include executable or interpretable code. In some embodiments, this code may include a software plug-in to the client application 110 or the computing facility 108.

The client application 110 may receive information from the service 102, thus facilitating in a user's viewing or interacting with the information. For example and without limitation, the client application may receive the information, present the information to a user, allow the user to interact with the information, receive inputs related to the interaction, and provide an indication of the interaction to the service 102.

The client application 110 may include an API having functions that are callable by service. The API may be used to interact with the native API of a computing facility 108 to access various resources, such as files, contacts, photos, videos, GPS location, maps, places, landmarks, routes, messages, bookmarks, calls history, calendar, notes, camera, radio, ring tones, music, playlists, device settings, device position, battery charge level, current time, and so on.

The network fabric 112 may include a data network composed of wired or wireless segments under one or more domains of administrative control. In embodiments, the wireless segments may include technologies such as cellular, satellite, WiFi, WiMax, or the like. The network fabric 112 may include a local area network, wide are network, metropolitan area network, personal are network, WiFi network, the Internet, and so on. In some embodiments, the network fabric 112 may include private networks of an enterprise, virtual private networks, and so on. It will be understood that a variety of embodiments of the network fabric 112 are possible.

The resources 114 may include physical or informational items. Each of the resources 114 may be assigned an identifier such as and without limitation a URI, IRI, RFID, or the like. The resources 114 may be accessible to the client application 110 via the network fabric 112. The resources 114 may include logic in the form of scripts, executable code, or the like. For example and without limitation, the resources 114 may include JavaScript, ActiveX, or the like.

The semantic objects 118 may include AnnoMinds Objects. AnnoMinds Objects may include Annotea objects that are extended with some service-specific semantics and a universally unique identifier. AnnoMinds Objects may include semantic annotations, bookmarks, topics, presentation objects, landmarks, facets, facet spaces etc. and in some cases combinations of these. In some embodiments, Annotea Object templates may let users create new Annotea objects based on some predefined definitions and user given data. In some embodiments, the semantic objects 118 may include a universally unique identifier and a collection of semantic information such as a title, a description, information about a creator, a creation date, an updating date, and so on. Some semantic objects 118 may include references to resources, the references either associating a target resource to the object like when a bookmark recalls a resource or associating additional semantics to the object information and the target resource. For example and without limitation, the resource containing the additional semantics may be a foaf file or another semantic object 118. In embodiments the semantic objects 118 may include a bookmark, a topic, a presentation object, an annotation, a folkcet, a folkcet space, and so on. Each of the semantics objects 118 may itself be a resource to which other semantic objects 118 refer.

In embodiments semantic objects 118 may be logically attached to a resource, for instance to recall a resource or part of a resource with help of its topics. This may be referred to as “tagging” the resource. In embodiments a semantic object 118 may itself be tagged by logically attaching other semantic objects 118 to it. In some embodiments, tagging may also be generalized to include annotating.

In embodiments where the semantic object 118 is a folkcet space, the semantic object 118 may use an RDF collection to list the folkcets that belong to the object. The following metadata is provided for the purpose of illustration and not limitation, and defines a folkcet space object with two folkcets that link to topics that are going to be used as root topics in the folkcet:

```
<RDF:RDF xmlns:dc=http://purl.org/dc/elements/1.1/
    xmlns:bm=http://www.w3.org/2002/01/bookmark#
    xmlns:a=http://www.w3.org/2000/10/annotation-ns#
    xmlns:foaf=http://xmlns.com/foaf/0.1/
    xmlns:RDFS=http://www.w3.org/2000/01/rdf-schema#
    xmlns:RDF=http://www.w3.org/1999/02/22-rdf-syntax-ns#
    xmlns:fc=http://www.w3.org/2001/Annotea/schemas/2006/04
    /folkcet#>
<fc:folkcetSpace RDF:about=“ .../folkcetspace”>
    dc:title=“sample folkcetspace”
    a:created=“Fri, 14 Dec 2007 14:10:39 GMT”
    dc:description=“folkcetSpace with two folkcets”
    dc:creator=“Marja”
    dc:date==“Fri, 14 Dec 2007 14:10:39 GMT”>
<foaf:maker
    RDF:resource=“http://www.annotea.org/marja#marja”/>
<fc:folkcets RDF:parseType=“Collection”>
    <bm:Topic
    RDF:about=“http:// ... 2 Oct 2006 14 09 44 GMT”/>
    <bm:Topic
    RDF:about=“http:// ... 2 Nov 2006 21 02 45 GMT”/>
</fc:folkcets>
</fc:folkcetSpace>
```

A handheld tagging facility 120 may include the computing facility 108. For example and without limitation, a user may have a computing facility 108 including an accelerometer, a camera, a screen, a GPS receiver, and a computer, all in a handheld form factor.

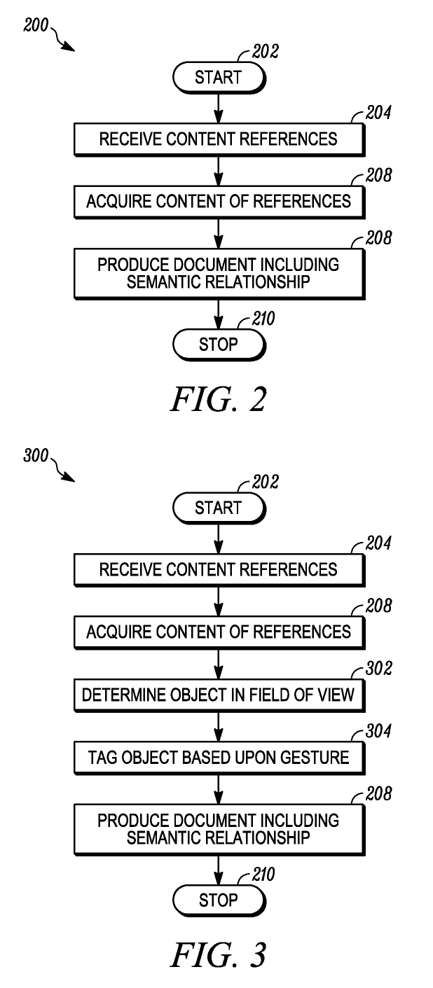

FIG. 2 shows a method that produces a document including semantic relationships. The method 200 begins at block 202 and receives a plurality of content references as shown by block 204. Then, at block 208 the method 200 acquires at least a portion of content referenced by the content references. Finally, the method 200 produces a document including semantic relationships (a.k.a. a “tagging knowledgeable document”) from the acquired portion of the content. In particular, this document may include semantic relationships associated with the content references. In some embodiments, the content references may include at least one of a bookmark, an annotation, a topic, a presentation object, a folkcet, a facet, a taxonomy, and a folksonomy. In some embodiments, the document may include at least one of a printed document, a report, a multimedia presentation, an on-line document, an electronic file, a Wiki, a blog, a map, and so on. In some embodiments, acquiring the portion of content may include acquiring content based on a transformation of the content references. In some embodiments, producing the document may include producing a portion of an existing document. In some embodiments, a plurality of users may produce portions of the document.

FIG. 3 shows an augmented version of the method 200 of FIG. 2. This method 300 further includes determining an object in a field of view of a handheld tagging facility 120 and tagging the object based on a detected gesture made with handheld tagging facility 120 (as shown by blocks 302 and 304, respectively). The handheld tagging facility 120 may include the computing facility 108. For example and without limitation, a user may have a computing facility 108 including an accelerometer, a camera, a screen, a GPS receiver, and a computer, all in a handheld form factor. The user may point the camera at an historic landmark so that the landmark appears in the screen. Then, the user may jostle the computing facility 108 with a side-to-side motion. The accelerometer may detect this motion and, in turn, the computing facility 108 may tag the object with the geographic location of the computing facility 108 at the time of tagging and the currently selected default topics. Generally, it should be understood that tagging the object in the field of view may involve first creating or updating a resource (in the above example, the resource may be an image of the historic landmark) and then creating or updating a semantic object 118 that is finally attached to the resource. In some embodiments the document that is produced at step 208 may relate to both the object in the field of view, maybe some audio explanation and semantic relationships from the acquired portion of the content. This semantic information of this trip can be viewed as a path in a map, as a sequence of images and audio clips, or as a faceted interface including selected tags and so on. In addition to storing the trip information, parts of it may be shared and watched in real time from a picture frame type of a device or by using a special IRC that lets people also comment the views. The created document may be RDF, XHTML with RDF, image with semantics or some other kind of document.

In embodiments, the object in the field of view may be a product, a person, a store, a location determined from a plurality of objects, and so on. In embodiments, the handheld tagging facility 120 may include a sensor that is operatively coupled to a wireless segment of the network fabric 112. In some embodiments the sensor may include a camera. In some embodiments the tagging facility 120 may include a mobile phone.

The methods 200 and 300 may be directed at user-authored documents that are dynamically updated. Such user-authored documents may be referred to herein and elsewhere as annolets. In embodiments these documents may include complete documents, parts of documents, maps, music lists, video highlights, menus, reference lists, and so on. These documents may include content that is generated by tagging and presentation widgets. This is illustrated by the example in the following paragraph.

For example and without limitation: The service 102 may let an expert both create code and attach the code to a presentation object (i.e. tag the presentation object with the code). In embodiments, the code may include rules and queries and may be encoded as an XSLT document, JavaScript, and so on. Then, the service 102 may allow the expert to create an annolet template that lets a user select a facet from available facets or add a URI of a known facet to the template. In addition, the expert may let the user select a suitable presentation object. In embodiments such suitability may be defined by using the expert topics and other characteristics. Finally, the expert may create annolet code that combines the presentation code with the facet information and creates an HTML document that refers to the XSLT. When the user adds the attribute information to the template she creates an annolet with a URI and all the above information. It may also be tagged under some topics. Now one may use the annolet by referencing the URI or embedding it to another page. It will be understood that a variety of technologies may be used instead of XSLT, JavaScript, and HTML.

The presentation of an annolet may be defined by selecting an annolet template that offers a user a widget presentation and means to customize it e.g. by adding references to AnnoMinds objects such as annotations, bookmarks, topics, facets, facet spaces etc. The annolet may integrate the content info with the presentation, marked with an ID, named as any other AnnoMinds object, augmented with other semantic information including dates and creator, thereby making it is ready to be used (e.g. by linking to it in a document or a Wiki page).

An annolet may also include interaction definitions that create new AnnoMinds objects or update existing AnnoMinds objects. These actions can be activated by using any input objects e.g. buttons but also gestures or even some context info. For instance, a set of gestures and related bookmark and topic creation can be defined by using an annolet. In this case a defined gesture with a device may create a landmark with a selected topic (e.g. a “gas station”) or a user looking to buy a new DVD player can tag a device she is looking at under a category “DVD player”, and the current location.

AnnoMinds objects may be automatically created (e.g. when a device sends location info to a path annolet). The annolet can be programmed to automatically create a new landmark object, give it a name and a new topic (e.g. “Path02112008”) and tag that topic under a “path” topic. Naturally the device itself can also be programmed to create the landmarks. When another user links to a path map annolet referring to a “Path02112008”, may will show the sent landmarks on a map organized by time. It may even be checking to see if the topic has some new landmarks and update the presentation accordingly.

As with any AnnoMinds objects the annolets can be given topics that allow a user to see and organize them in the topic hierarchy. They can be linked with documents, Wiki pages, blogs, maps etc. where they are presented as if they were authored parts of the content while they are dynamically updated each time the user updates the topics that the annolet refers to. Some applications can also provide their own sets of annolets that combine presentation and interaction with the links to AnnoMinds objects. In this case a semantic service system may provide users the templates to add the topic, facet etc. links to generate the presentation of these objects.

Annolet spaces can integrate several annolets together.

Annolets can use user defined topic fingerprints to select presentations for certain topics. For instance, a topic Boston can be a subtopic of “location” and may contain a set of bookmarks that have other topics as well. An annolet can have rules that show the resource that has a parent topic that is a “location”, that has a “googlemap” topic located in a right presentation corner, a resource that has a “weather” topic in the left portion of the presentation, and “tourist info” under that.

Fingerprints can represent a pattern or other information structure associated with a topic, bookmark, annotation, or any semantic web object. A user can define or reference any number of fingerprints. Fingerprints can be changed by user actions, by automatic updates of information associated with the fingerprint, and the like. A fingerprint may be associated with a single user, a group of users, may be independent of a user and be associated with a topic, a transaction history associated with a topic, bookmark, web site, semantic object, and the like. A fingerprint may represent a user friendly term for aspects of the semantic web that enable a user to access the semantic web without understanding all of the complexities underlying the fingerprint.

Example annolets include a spreadsheet where users can calculate different combinations of topics by referencing topics or facets in columns and rows. Sometimes an annolet can be attached also to the cells of a spreadsheet thereby automatically getting its arguments from data in the columns and rows and possibly other information available in the context.

Annolets can present given topic hierarchies as Mindmaps. Calendars or maps can be annolets. A calendar can show events related to certain topics or facets. In an example, a user may select facets or topics from a menu and then filter the events in the calendar so that only the ones having the selected topics are shown. Similarly maps can present locations related to certain topic areas.

Annolets can be also defined so that they are tied to some available context information e.g. current Web page if the annolet is attached to a Web page, current pulse if the annolet is attached to a device providing the pulse etc.

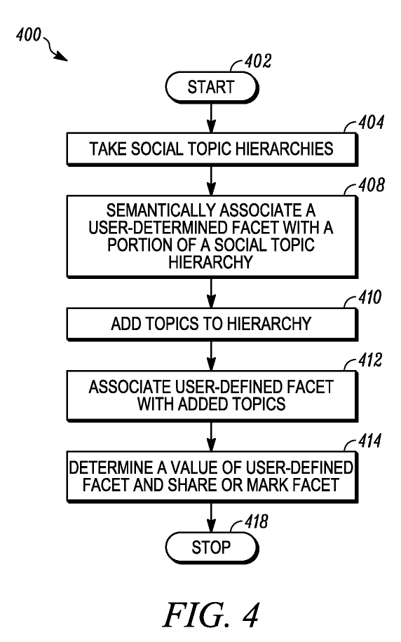

FIG. 4 shows a method that associates a user-defined facet with a topic based upon semantic analysis. The method 400, which begins at block 402, takes social topic hierarchies as shown by block 404. Then, the method 400 semantically associates a user-determined facet with a portion of the social topic hierarchies as shown by block 408. In block 410, the method 400 adds topics to the social topic hierarchies. In block 412, The method 400 may automatically associate the user-defined facet with the added topics based on a semantic analysis of the added topics. In some embodiments, the facets may be dynamically created. In some embodiments, the facets may be created in real-time. Optionally, as shown by block 414, the method may determine a value of the user-defined facet and, based on the value, perform at least one of sharing the user-defined facet, marking the user-defined facet as a deprecated, or any and all other action related to the facet. It will be understood that a variety of such actions are possible and all such examples are within the scope of the present disclosure. In some embodiments, the value of the user-defined facet may be determined by a common policy associated with the social topic hierarchies. In some embodiments the value may be determined by usage of the facet.

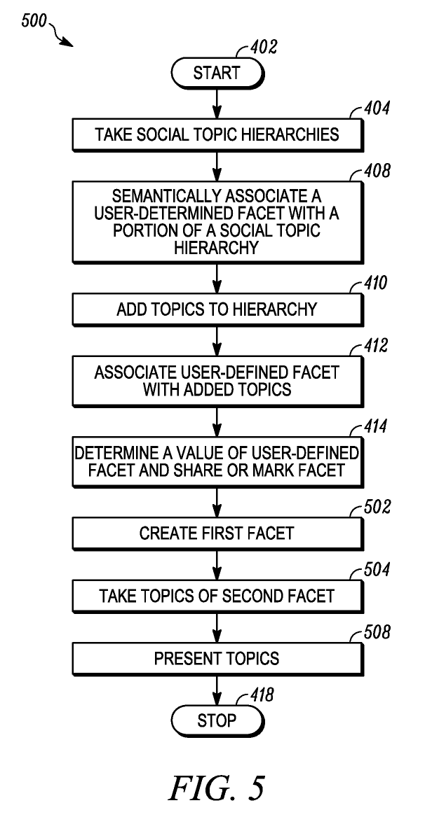

FIG. 5 shows an augmented version of the method 400 of FIG. 4. This method 500 may further include creating a first facet (as shown by block 502); taking topics that are associated with a second facet (as shown by block 504); and presenting the topics so that topics that are associated with the first facet are presented as subtopics of the second facet (as shown by block 508). In some embodiments, the first facet may already exist and block 502 may be modified to represent taking the first facet (as opposed to creating it). In some embodiments, the subtopics may be visually distinct. In some embodiments, the topics may be presented according to a template.

The facet template may include a selection of topics from social topic hierarchies, Boolean definitions of how the topic selections are combined (explained in user understandable vocabularies), and other AnnoMinds object related info such as title, description, creator and dates of the facet. Several facets can form a facet (folkcet) space. When users add new subtopics under the topics selected for a facet, the facet may change dynamically reflecting the users' current understanding of topic hierarchies.

Facets and facets spaces can be used and presented in many ways. For instance, several facets (facet space) can form a faceted interface for searching purposes. A facet can also be used to focus the interface on certain interest area e.g. by showing the topics in the facet as root topics in the service.

A facet can also be used to help users improve functionality of topic hierarchies by creating narrower facets that the user can select to form new virtual topics. A narrower virtual topic is a facet that creates an intersection of several topics. It can be linked and it can show the topics, bookmarks and other objects under it. It may be shown in a topic hierarchy as if it were a normal topic but can still be in some way may be visually distinct. A broader topic is done by creating a normal topic and linking all component topics together. A semantic service can provide guidance to a user regarding how to use these mechanisms.

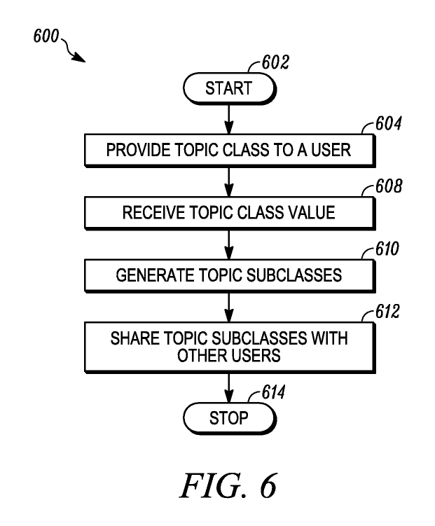

FIG. 6 shows a method that enables sharing of topic subclasses. The method 600, which begins at block 602, provides a topic class to a user (block 604). Then, as shown in block 608, the method 600 receives a topic class value in response. At block 610, the method 600 generates topic subclasses based on the response. Finally, at block 612, the method 600 shares the topic subclasses with other users. In some embodiments, the topic class may be time related. In some embodiments, generating the topic subclasses may include identifying the topic subclasses with user defined names.

A semantic service can be tailored e.g. for an organization purposes to offer users some topics or other objects made by experts (content or IT experts) in the organization. These topics can be virtual in a sense that they can be calculated based on organization and other available data sources and possibly on data sources from other services. Virtual topic templates let users provide some input for the calculations of virtual topics.

The service can provide guidance to a user of how and when to use these topics. In some contexts, (e.g. when using deprecated topics), it can suggest to a user other topic alternatives.

Organizations can tailor a semantic service system to help support the organization functions by providing topics, facets, presentation objects etc. Organizations can also provide support and learning material linked to these objects to explain benefits and usage of these topics. For instance, organization can provide a topic “deprecated” that can be used to inform teams to use some other topics because the goal is to gradually stop using this topic and start using another topic.

Organizations can provide virtual topics that are topics with calculated values. These may be defined by computer science knowledgeable experts in an organization or community. In an example of these kinds of topics, a “new” topic will retrieve date information from an object and can be virtually attached to any object that meets the calculated criteria for “new”.

Finally, organizations can provide virtual topic templates that users can use to create virtual topics. For instance, a virtual topic template for “new” would let the user define an exact time after which everything would be considered new, or a relative time (e.g. a day or a week before current time) that would be considered new. Naturally nothing would prevent the virtual topic from also using the information about user visits with this objects and attach “new” only if the time meets the requirements of new and the user has not visited the object yet.

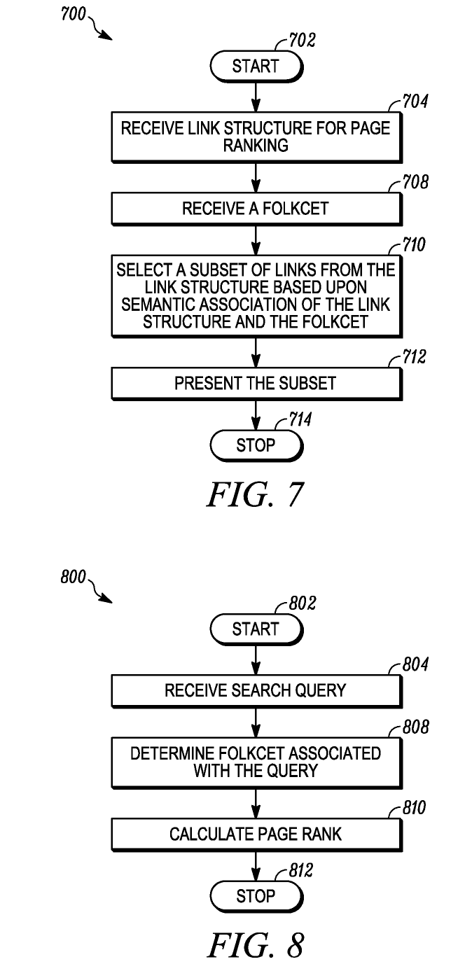

FIG. 7 shows a method that presents ranked pages by using a folkcet. The method 700 begins at block 702 and then receives a link structure for page ranking (block 704) and receives a folkcet (block 708). The method 700 selects a subset of links form the link structure based on a semantic association of the link structure and the folkcet, as shown by block 710. Then, the method 700 presents the selected subset of links as ranked pages, as shown by block 712.

FIG. 8 shows a method that calculates a page rank using a folkcet. The method 800 begins at block 802. The method 800 receives a search query (block 804); determines a folkcet that is associated with the query (block 808); and calculates a page rank for candidate search query results based on a similarity of the candidate results to the folkcet. (block 810). In some embodiments, the folkcet may be user-specified. In some embodiments, the folkcet may be automatically generated based on a query. In embodiments, the search may be based on text and associated folkcets, which may include any and all sets of topics, bookmarked documents, annotated documents, users, semantic data, and so on.

A user can select a facet or facet space to be used as a starting point for a page rank algorithm. The service can use the page rank links with other information and offer to store and calculate these specialized page ranks for organizations according to their selections. Such calculation may be done in real time.

In this case the bookmarked resources under the topics in the facets will be given 100% weight as they are specifically selected by users. Links to and from these pages will be given high weights as well. Different algorithms can be used and results compared with original sets and user selections. The visited information and other ranks can further be used to bring page rank higher.

Also the results from such a search can be presented as a list where each search result has information based on user created topics and system calculated topics or the results can be organized under the user selected topic hierarchies or the user can include or exclude topics from a facet and the results change accordingly. This can be a faceted interface in which some results are calculated based on user tags and page rank etc. while others are actually tagged by users. In this interface a user can select to confirm some calculated tags in which case they become part of the semantic definition of the ranked pages.

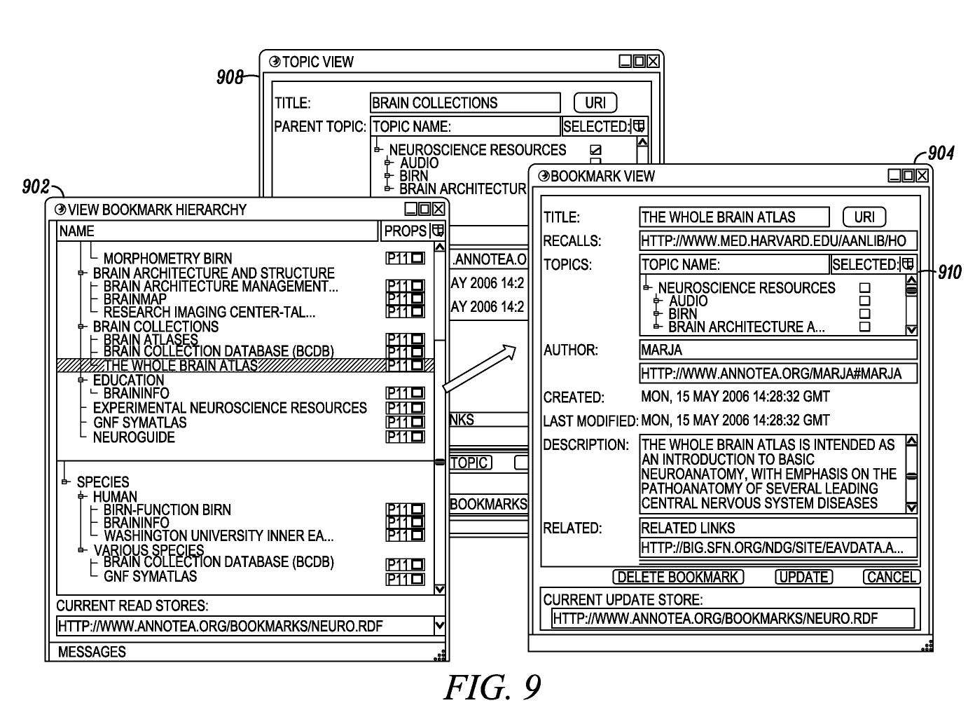

Annotea objects, bookmarks, topics, and other semantic based elements can be presented to users in a user oriented context without a need for the user to know anything about semantic techniques related to organizing and accessing and the web. A service system that facilitates presentation of semantic based elements as herein described may enable a user to access the semantic web without knowledge or training in semantic analysis techniques. The presentation of objects, bookmarks, topics, semantic elements, and the like is also herein referred to as semantic authoring. An advantage of using a bookmark metaphor for semantic authoring is that it nicely supports semantic authoring and presentation of Annotea bookmark and topic objects, their collections. It also facilitates presenting context sensitive views of these objects. Referring to FIG. 9, a simple user interface allows user to explore bookmark or topic information. A bookmark hierarchy 902 can be accessed through the user interface e.g. the browser toolbar or a service and a bookmark such that a bookmark “The Whole Brain Atlas” may be selected which may produce a new user interface window that is the bookmark view 904. The bookmark view 904 may present the bookmark's properties and values including its topics. Here the bookmark is associated with topic “Brain Collections” in both views 902 and 910. This topic content can be presented in the topic view 908. The topics section 910 in the bookmark view 904 may depict the topic information associated with the bookmark. The information in the topics section 910 may match the parent topic section of the presentation of the topic in the topic view 908. Presentation properties can be added to Annotea objects to facilitate presenting different information when an Annotea object (e.g. bookmark view 904) is viewed. A presentation facility associated with the semantic service system 100 may evaluate Annotea object presentation properties to identify presentation guidance based on the properties. Such a facility may automatically present objects.

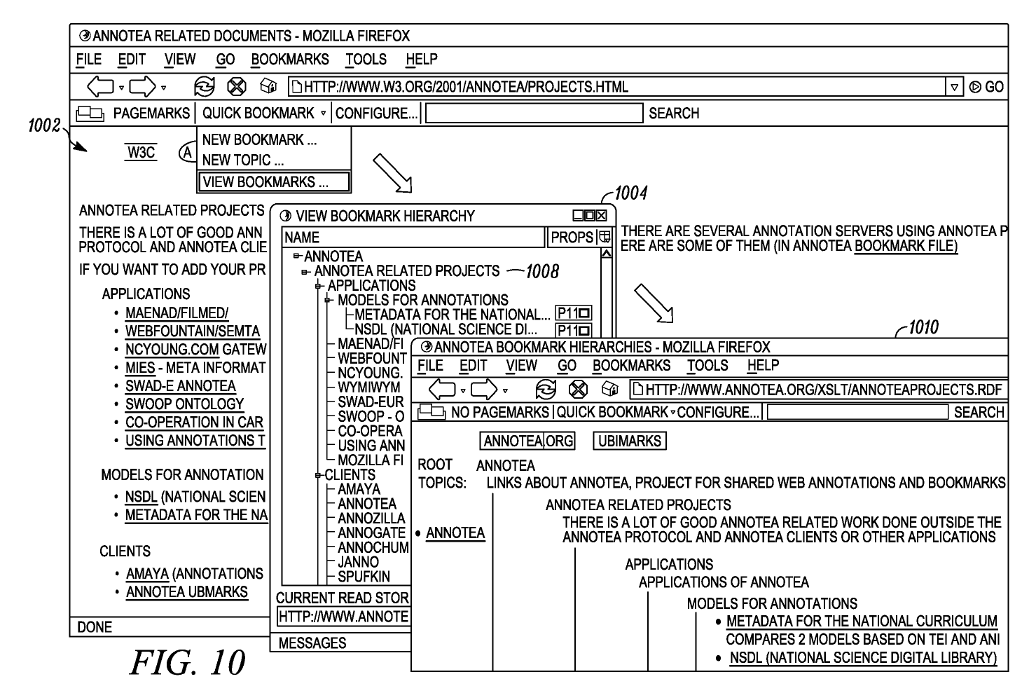

The methods and systems of a semantic service system described herein may allow authors to create and maintain shared classifications or topics. An example of creating and sharing topics may include cataloging a bookmark under one or more topics and presenting it to a user, such as in a hierarchy view. In FIG. 10 methods and systems of a semantic service system may create bookmarks for a web page 1002. The created bookmarks may then be viewed as a hierarchy of bookmarks related to the web page in a view bookmark hierarchy window 1004. In the example of FIG. 10, the view bookmark hierarchy window 1004 shows a hierarchy of Annotea related projects 1008 derived from the web page 1002. A user may interact with the view bookmark hierarchy window by clicking a bookmark title in the hierarchy to open the bookmarked page. In the example of FIG. 10, clicking a bookmark title will open web page 1002.

The presentation related methods and systems herein may facilitate creating a corresponding XHTML page directly from the bookmark semantics such as through an XSLT transformation. Transformed browser window 1010 shows one example of such a transformed page. The style of the created page can be easily changed to bear even closer resemblance to the original page or to any user preferred style. A browser window presented through this creation process allows a user to gain substantial benefits from the semantics associations possible with a semantic service system without complex training or practice.

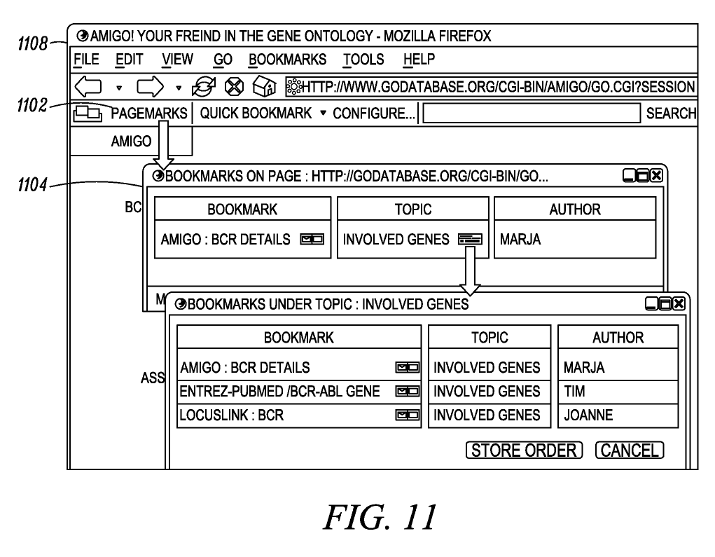

Referring to FIG. 11 that shows context dependent views of bookmarks and topics, a user interface may provide information about related Web documents in a current web document context. A user may browse through web pages and find something interesting. If the web page of interest includes a “Pagemarks” icon 1102, then one or more users has bookmarked it. The “Pagemarks” icon may be an interactive icon and may be clicked to open a view 1104 listing all the bookmarks on the page. These bookmarks and their topics can be easily followed to find related documents. In an embodiment exemplified in FIG. 11, users collaborating in related research areas can benefit from the bookmark and topic information by finding related topics and bookmarks. In FIG. 11, a first user has bookmarked a gene page in Amigo 1108 other users can add bookmarks through the Pagemarks 1102 icon included with the page as a result of the first user bookmarking the page. Later when the user browses the page, the Pagemarks 1102 icon can be opened to reveal bookmarks, topics, and more information about the genes involved in CML leukemia made by other researchers who accessed and bookmarked the page. These other researchers can be in other departments of the institution or in other institutions. Additionally, user generated information can be mapped onto automatic categorization sources such as categorization databases, to help the user to find non-bookmarked but relevant resources and thereby potentially make new innovative associations. Similarly, the user's location (including some area around it) may be taken as a context within which to find other bookmarked locations, which may exist within the selected facet or the selected user group.

A semantic service system can provide similar functionality to pagemarks independently of a web browser add-in as shown in FIG. 11. By using bookmarklet features of a semantic service system, a user can access, display, select, and process pagemarks and other references. In this way, a user of a semantic service system can manage a rough equivalent of pagemarks separate from a strictly web browser based interface. Bookmarklets may facilitate access by standalone user interfaces, devices adapted to support bookmarklets, software (e.g. API based program), web services, and the like.

By separating the semantic data associated with Annotea objects from presentation objects, the presented order of bookmarks can be defined by a user, another resource (e.g. a topic to guide its presentation), and the like. The presentation objects may let users define customized presentation order for a shared hierarchy so that each user may define a personal presentation order.

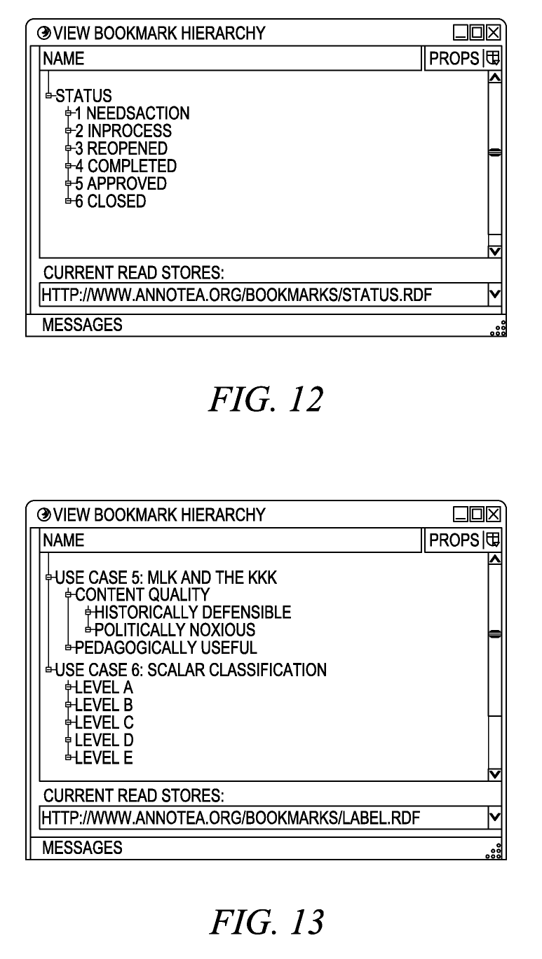

As described elsewhere herein, topic hierarchies do not have to have a common root topic. Topic hierarchies may have several roots. This facilitates viewing topic hierarchies even when some topics are unavailable. Hierarchies containing several root topics can be also viewed in multifaceted displays. By supporting multiple roots, a semantic service system may allow a user to easily define concept hierarchies that are intended to be used in parallel with other concepts. FIG. 12 which depicts workflow status and FIG. 13 which depicts content label hierarchies are such examples.

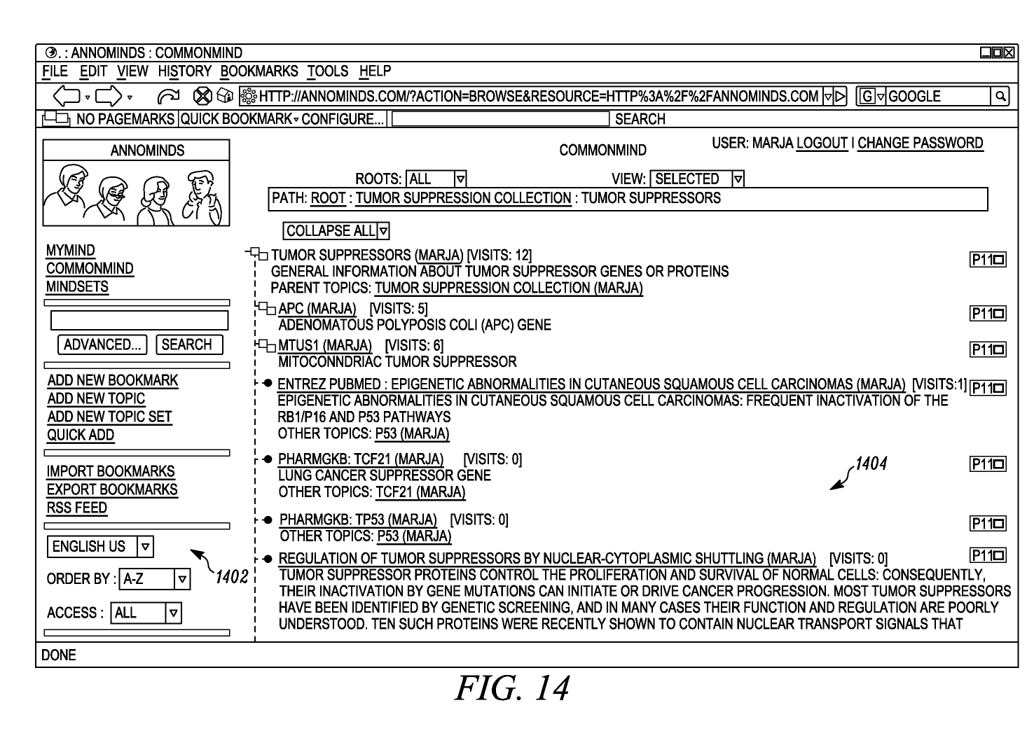

FIG. 14 depicts an exemplary user interface of a portion of a semantic service system. The user interface of FIG. 14 includes a top menu area 1402 and a semantic object viewing area 1404. In the embodiment of FIG. 14, the semantic object viewing area 1404 includes a hierarchy display of objects such as bookmarks, and topics. This is just one example of a user interface of a portion of a semantic service system.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A semantic service system, comprising:
a tagging facility for collecting references to resources, providing tagged resources;
a semantic database for storing the collected references;
a semantic associating facility for determining semantic relationships among the references and the resources, providing semantic objects; and
a user interface for presenting context-based views of one or more of the semantic objects, the references, and the tagged resources.

2. The system of claim 1, wherein the tagging facility comprises a handheld tagging device.

3. The system of claim 2, wherein the handheld tagging device comprises a computing facility with a camera for acquiring images of resources.

4. The system of claim 3, wherein the handheld tagging device comprises a motion sensor for detecting a user tagging gesture.

5-7. (canceled)

8. The system of claim 1, wherein the semantic objects comprise one or more of annotations, bookmarks, topics, facets, folkcets, folksonomies, and annomind objects.

9. The system of claim 1, wherein the semantic objects include a unique ID that facilitates distinguishing between two semantic objects with substantially identical content.

10. The system of claim 9, wherein the distinction is a semantic difference.

11. (canceled)

12. The system of claim 9, wherein the distinction is associated with a context-based view.

13-14. (canceled)

15. The system of claim 1, wherein the semantic associating facility transforms a portion of the collected references based on references in the semantic database.

16. A method of integrating content with presentation, comprising:
generating content by referencing a set of semantic objects;
customizing a presentation widget;
integrating the generated content with the customized presentation widget, providing an annolet;
identifying the annolet; and
associating semantic information with the annolet.

17. The method of claim 16, wherein referencing includes one or more of tagging and bookmarking.

18. The method of claim 16, wherein generating content includes coping content from a resource identified by the set of semantic objects.

19. The method of claim 16, wherein customizing a presentation widget includes a presentation order of the generated content.

20. The method of claim 16, wherein integrating includes referencing one or more annomind objects to select a subset of the generated content.

21. (canceled)

22. The method of claim 16, wherein the presentation widget is adapted based on one or more related annomind objects.

23. (canceled)

24. A method of generating a user authored, dynamically updated reference, comprising:
receiving a user tagging action;
determining a resource associated with the tagging action;
determining a plurality of semantic aspects of the resource; and
presenting a portion of the plurality of semantic aspects based on the user context.

25. The method of claim 24, wherein the user tagging action is implicit.

26. The method of claim 24, wherein the user authored, dynamically updated reference is a semantic object.

27. (canceled)

28. The method of claim 26, wherein the semantic object is a landmark object.

29. The method of claim 26, wherein the semantic object is an annolet.

30-31. (canceled)
